(19) United States
(12) Patent Application Publication
(10) Pub. No.: US 2008/0123011 A1
(43) Pub. Date: May 29, 2008

(54) Liquid crystal display device having decouple layers

(75) Inventor: Wei Wang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/986,804

(22) Filed: Nov. 26, 2007

(30) Foreign Application Priority Data
Nov. 24, 2006 (CN) 200620016001.6

(51) Int. Cl. G02F 1/136

(52) U.S. Cl. 349/46

(57) ABSTRACT

An exemplary liquid crystal display device (20) includes a first substrate (21), a second substrate (23) parallel to the first substrate, and a liquid crystal layer (25) disposed between the first substrate and the second substrate. The first substrate includes a common electrode (24) adjacent to the liquid crystal layer. The second substrate includes a plurality of gate lines (26), a plurality of data lines (28) perpendicular to the gate lines, a plurality of first decouple layers (261) formed on the gate lines and a plurality of second decouple layers (281) formed on the data lines. The first and second decouple layers are connected to ground.

### FIELD OF THE INVENTION

The present invention relates to liquid crystal display (LCD) devices, particularly to an LCD device having a stable actual common voltage.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 4 is an exploded, isometric view of part of a typical LCD device 10. The LCD device 10 includes a first substrate 11, a second substrate 13 parallel to the first substrate 11, and a liquid crystal layer 15 sandwiched between the two substrates 11, 13.

A common electrode layer 14 is formed on the first substrate 11, adjacent to the liquid crystal layer 15. The common electrode layer 14 covers substantially an entire surface of the first substrate 11, and generally is a transparent conducting layer.

The second substrate 13 includes a plurality of gate lines 16 that are parallel to each other, a plurality of data lines 18 that are parallel to each other and perpendicular to the gate lines 16, and a plurality of pixel electrodes 17. The gate lines 16 intersect with but are insulated from the data lines 18. Each of the pixel electrodes 17 is formed in an area enclosed by two adjacent gate lines 16 and two adjacent data lines 18. The gate lines 16 and the data lines 18 generally face toward the common electrode layer 14. Thus each gate line 16 and the common electrode layer 14 constitute a coupling capacitor, and each data line 18 and the common electrode layer 14 constitute a coupling capacitor.

When the LCD device 10 displays images, a predetermined common voltage is applied to the common electrode layer 14, and a gray scale voltage is applied to each of the pixel electrodes 17. Thus, an electric field is generated in the liquid crystal layer 15. A transmittance of light passing through the liquid crystal layer 15 is adjusted by controlling the strength of the electric field, thereby obtaining desired images.

The voltages of the gates line 16 and the data lines 18 are quickly changed, and the actual common voltage may be rippled because of the coupling effects of the coupling capacitors. That is, desired voltage-transmittance characteristics of the liquid crystal layer 15 are shifted, and this typically leads to a deterioration in the quality of images displayed.

What is needed, therefore, is an LCD device that can overcome the above-described deficiencies.

### SUMMARY

In one preferred embodiment, a liquid crystal display device includes a first substrate, a second substrate parallel to the first substrate, and a liquid crystal layer between the first substrate and the second substrate. The first substrate includes a common electrode adjacent to the liquid crystal layer. The second substrate includes a plurality of gate lines, a plurality of data lines perpendicular to the gate lines, a plurality of first decouple layers formed on the gate lines and a plurality of second decouple layers formed on the data lines. The first and second decouple layers are connected to ground.

Other aspects, novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of part of a liquid crystal display device according to an exemplary embodiment of the present invention.

FIG. 2 is a cross-sectional view taken along line II-II of FIG. 1.

FIG. 3 is a cross-sectional view taken along line III-III of FIG. 1.

FIG. 4 is an exploded, isometric view of part of a conventional liquid crystal display device.

### DETAILED DESCRIPTION OF PREFERRED EMBODIMENTS

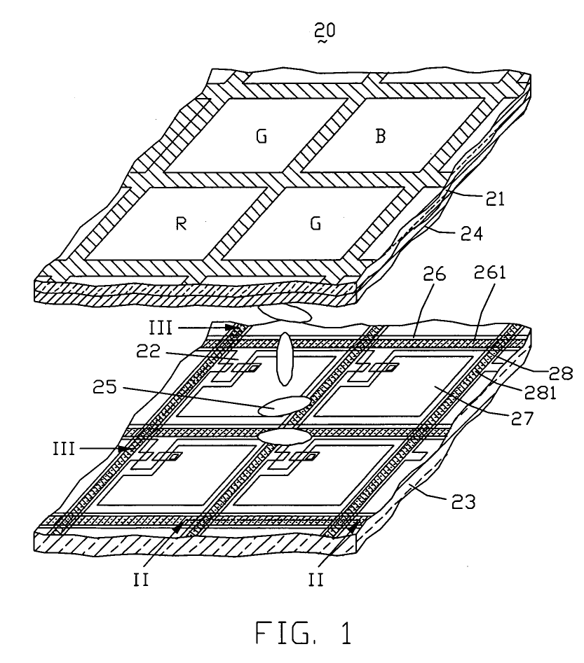

FIG. 1 is an exploded, isometric view of part of an LCD device 20 according to an exemplary embodiment of the present invention. The LCD device 20 includes a first substrate 21, a second substrate 23 parallel to the first substrate 21, and a liquid crystal layer 25 sandwiched between the two substrates 21, 23.

The first substrate 21 includes a common electrode layer 24. The common electrode 24 is formed on the first substrate 21, adjacent to the liquid crystal layer 25. The common electrode layer 24 covers substantially an entire surface of the first substrate 21. The common electrode 24 is a generally transparent conducting layer, and is typically made from indium tin oxide (ITO) or indium zinc oxide (IZO). The common electrode 24 has a predetermined common voltage applied thereto.

The second substrate 23 includes a plurality of gate lines 26 that are parallel to each other, a plurality of data lines 28 that are parallel to each other and perpendicular to the gate lines 26, a plurality of first decouple layers 261, a plurality of second decouple layers 281, a plurality of thin film transistors (TFTs) 22, and a plurality of pixel electrodes 27. The gate lines 26 intersect with the data lines 28, thereby defining a plurality of pixel units (not labeled). Each pixel unit includes a TFT 22 and a pixel electrode 27. Each TFT 22 includes a gate electrode (not labeled) connected to a gate line 26, a source electrode (not labeled) connected to a data line 28, and a drain electrode (not labeled) connected to a pixel electrode 27. Each TFT 22 serves as a switching element. The data lines 28 can be made from a refractory metal, such as chromium (Cr), titanium (Ti), or an alloy having either or both of these metals. The gate lines 26 can be made from a low resistance metal such as aluminum (Al) or an aluminum alloy.

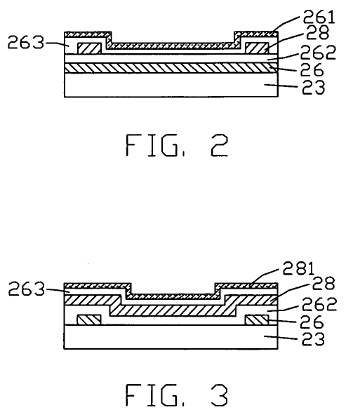

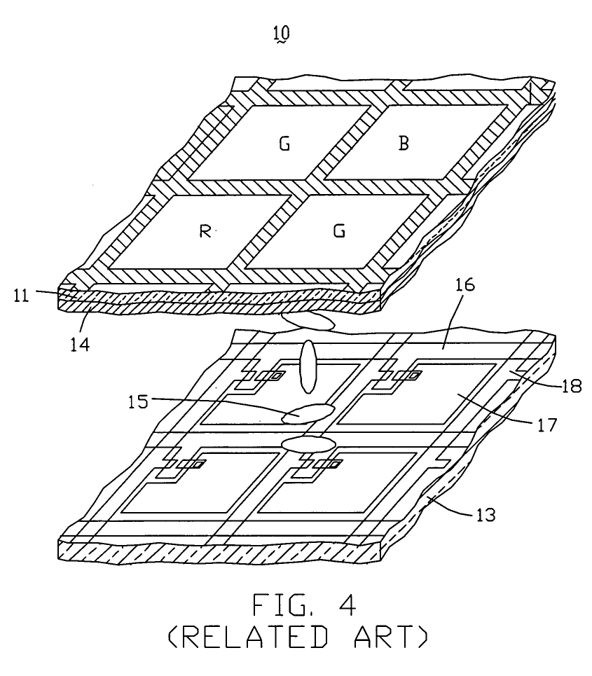

Referring to FIG. 2 and FIG. 3, the second substrate 23 further includes an insulating layer 262 and a passivation layer 263. The insulating layer 262 is formed on the gate lines 26. The data lines 28 are formed on the insulating layer 262. The passivation layer 263 is formed on the data lines 28 and the insulating layer 262. The first decouple layers 261 are formed on the passivation layer 263, and correspond to the gate lines 26 respectively. The second decouple layers 281 are formed on the passivation layer 263, and correspond to the data lines 28 respectively. A width of each first decouple layer 261 can be equal to, less than, or greater than a width of each gate line 26. A width of each second decouple layer 281 can be equal to, less than, or greater than a width of each data line 28. The first and second decouple layers 261, 281 are connected to ground. The insulating layer 262 can be made from SiNₓ or SiO₂. The passivation layer 263 can be made from SiO₂, SiNₓ (for example, SiN₂, SiN₃), or another suitable insulative material. The first and second decouple layers 261, 281 can be made from ITO.

When the LCD device 20 displays images, a plurality of gate-on voltages are applied in sequence to the gate lines 26. A plurality of gray scale voltages are applied to the data lines 28, and thus to the corresponding TFTs 22.

Each TFT 22 is turned on when a corresponding gate-on voltage is applied to the gate electrode thereof. Then, a corresponding gray scale voltage is applied to the drain electrode of the TFT 22 through the source electrode of the TFT 22. Consequentially, the gray scale voltage is applied to the corresponding pixel electrode 27. Thus, an electric field is generated due to a voltage difference between the pixel electrode 27 and the common electrode 24. Generally, if an electric field with the same direction is continuously applied to the liquid crystal of the liquid crystal layer 25, the liquid crystal is liable to be degraded. For this reason, the gray scale voltages are changed alternately between positive and negative values relative to the common voltage. Thereby, degradation of the liquid crystal is avoided.

Thus, variable voltages are continuously applied to the gate lines 26 and data lines 28. Because each of the first decouple layers 261 and the respective gate line 26 constitute a coupling capacitor, the variations of the voltage applied to the gate line 26 only have effect on the first decouple layer 261. The first decouple layer 261 is connected to ground, therefore the coupling effect is greatly reduced. The second decouple layers 281 have substantially the same function as the first decouple layers 261. Thus the actual common voltage can remain undisturbed and stable. As a result, the quality of images displayed by the LCD device 20 remains unimpaired.

Further or alternative embodiments may include the following. The first and second decouple layers 261, 281 can have an invariable voltage applied thereto. In such case, the first and second decouple layers 261, 281 can also prevent variations in the common voltage.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display device comprising:
a first substrate;
a second substrate parallel to the first substrate; and
a liquid crystal layer between the first substrate and the second substrate;
wherein the first substrate comprises a common electrode adjacent to the liquid crystal layer, and the second substrate comprises a plurality of gate lines, a plurality of data lines perpendicular to the gate lines, a plurality of elongate first decouple layers formed corresponding to the plurality of gate lines, and a plurality of elongate second decouple layers formed corresponding to the plurality of data lines, each of the first and second decouple layers being connected to ground.

2. The liquid crystal display device in claim 1, further comprising an insulating layer provided between the gate lines and data lines and a passivation layer provided on the data lines, the decouple layers being formed on the passivation layer.

3. The liquid crystal display device in claim 1, wherein the common electrode substantially covers an entire surface of the first substrate.

4. The liquid crystal display device in claim 1, wherein the gate lines are parallel to each other, the data lines are parallel to each other, and the gate lines intersect with the data lines to define a plurality of pixel units that each comprises a thin film transistor and a pixel electrode.

5. The liquid crystal display device in claim 1, wherein at least one of the following width configurations is provided: a width of each of the first decouple layers is equal to a width of each of the gate lines, and a width of each of the second decouple layers is equal to a width of each of the data lines.

6. The liquid crystal display device in claim 1, wherein at least one of the following width configurations is provided: a width of each of the first decouple layers is less than a width of each of the gate lines, and a width of each of the second decouple layers is less than a width of each of the data lines.

7. The liquid crystal display device in claim 1, wherein at least one of the following width configurations is provided: a width of each of the first decouple layers is greater than a width of each of the gate lines, and a width of each of the second decouple layers is greater than a width of each of the data lines.

8. The liquid crystal display device in claim 1, wherein the data lines are made from at least one material selected from the group consisting of chromium, titanium, and alloy having at least one of these metals.

9. The liquid crystal display device in claim 1, wherein the gate lines are made from aluminum or aluminum alloy.

10. The liquid crystal display device in claim 2, wherein the insulating layer is made from SiNₓ or SiO₂.

11. The liquid crystal display device in claim 2, wherein the passivation layer is made from SiO₂ or SiNₓ.

12. The liquid crystal display device in claim 2, wherein the first and second decouple layers are made of indium tin oxide.

13. A liquid crystal display device comprising:
a first substrate;
a second substrate parallel to the first substrate; and
a liquid crystal layer between the first substrate and the second substrate;
wherein the first substrate comprises a common electrode generally adjacent to the liquid crystal layer, the second substrate comprises a plurality of gate lines, a plurality of data lines perpendicular to the gate lines, a plurality of elongate decouple layers formed corresponding to the plurality of gate lines, and a plurality of elongate decouple layers formed corresponding to the plurality of data lines, and all the decouple layers are configured to have an invariable voltage applied thereto.

14. The liquid crystal display device in claim 13, further comprising an insulating layer provided between the gate lines and data lines, and a passivation layer provided on the data lines, the decouple layers being formed on the passivation layer.

15. The liquid crystal display device in claim 13, wherein the common electrode substantially covers an entire surface of the first substrate.

16. The liquid crystal display device in claim 15, wherein the common electrode is a transparent conducting layer.

17. The liquid crystal display device in claim 13, wherein the gate lines are parallel to each other, the data lines are parallel to each other, and the gate lines intersect with the data lines to define a plurality of pixel units that each comprises a thin film transistor and a pixel electrode.

18. The liquid crystal display device in claim 17, wherein each of the thin film transistors comprises a gate electrode connected to a corresponding gate line, a source electrode connected to a corresponding data line, and a drain connected to a corresponding pixel electrode.

19. The liquid crystal display device in claim 13, wherein at least one of the following width configurations is provided: a width of each of the decouple layers corresponding to the gate lines is substantially equal to a width of each of the gate lines, and a width of each of the decouple layers corresponding to the data lines is substantially equal to a width of each of the data lines.
